(19) United States
(12) Patent Application Publication
(10) Pub. No.: US 2012/0149268 A1
(43) Pub. Date: Jun. 14, 2012

(54) METHOD FOR IMPROVING IMPACT DAMAGE RESISTANCE TO TEXTILE ARTICLES, AND ARTICLES MADE THEREFROM

(75) Inventors: Scott C. Lake, West Chester, PA (US); Leonard W. Harvey, Downingtown, PA (US); Michael J. Lindstrom, Downingtown, PA (US)

(73) Assignee: Whitford Corporation, Elverson, PA (US)

(21) Appl. No.: 13/392,328

(22) PCT Filed: Aug. 27, 2010
(86) PCT No.: PCT/US10/46884

§ 371 Date: Feb. 24, 2012

Related U.S. Application Data
(60) Provisional application No. 61/237,390, filed on Aug. 27, 2009.

(51) Int. Cl. B32B 5/02; B29C 70/08

(52) U.S. Cl. 442/172; 264/257

(57) ABSTRACT

The treatment of textile articles, such as sleeves made of mineral fibers of the type that are used with automotive exhaust system components, by impregnating the textile articles with treatment compositions of various formulations including fluoropolymers and/or mixtures of fluoropolymers with co-resins, followed by heat treatment to cure the compositions, thereby providing protection against impact damage to the sleeve. The treatment serves to impart enhanced resistance to damage of the sleeve by holding the overall fibrous structure of the sleeve together during impact such as by stone impingement, even if underlying fibers themselves are broken or damaged.

### CROSS REFERENCE TO RELATED APPLICATIONS

This application is based on and claims priority under Title 35, U.S.C. §119(e) to U.S. Provisional Application Ser. No. 61/237,390, filed Aug. 27, 2009, titled “Method for Improving Impact Damage Resistance to Textile Articles, and Articles Made Therefrom,” the entire disclosure of which is expressly incorporated herein by reference.

### BACKGROUND OF THE DISCLOSURE

1. Field of the Disclosure

The present disclosure provides a method for improving the resistance to impact damage of articles made of textiles and/or fibers, and textile and/or fiber articles made therefrom. In one embodiment, the present disclosure provides a method of imparting greatly improved resistance to impact damage to textile sleeves, such as sleeves made of basalt fibers of the type that are used with vehicular exhaust systems.

2. Description of the Related Art

Tubular sleeves made from materials that can withstand high temperatures have been used to insulate various pieces of equipment, such as exhaust pipes or other vehicular exhaust system components, for example, that operate at relatively high temperatures. The sleeves protect surrounding structures from becoming damaged by heat radiating out from the object, and also provide insulation to the object to allow it to operate at higher temperatures. The tubular sleeves can have various constructions and are commonly made from heat resistant materials including various mineral fibers like silica, ceramics, basalt, and the like.

While these sleeves provide excellent thermal insulation properties, they are prone to degradation due to external environmental abrasive elements. When the sleeves are used to insulate, for example, an underbody automotive exhaust pipe, they are easily damaged by stones, sticks, or other roadway debris that impact the sleeve. The mineral fibers used in the construction of the sleeves, while highly heat resistant, are extremely fragile and brittle and are easily damaged by the impingement of stones or similar debris even at low velocities.

What is needed is a method for improving the resistance to impact damage of articles made of textiles and/or fibers which is an improvement over the foregoing.

### SUMMARY

The present disclosure relates to the treatment of textile articles, such as sleeves made of mineral fibers of the type that are used with automotive exhaust system components, by impregnating the textile articles with treatment compositions of various formulations including fluoropolymers and/or mixtures of fluoropolymers with co-resins, followed by heat treatment to cure the compositions, thereby providing protection against impact damage to the sleeve. The treatment serves to impart enhanced resistance to damage of the sleeve by holding the overall fibrous structure of the sleeve together during impact such as by stone impingement, even if underlying fibers themselves are broken or damaged.

In one form thereof, the present disclosure provides a treated article, including a substrate comprising a mineral fiber; and a treatment composition applied to said substrate, said treatment composition including at least one fluoropolymer; and at least one co-resin different than said at least one fluoropolymer, said at least one co-resin selected from the group consisting of fluorinated ethylene-propylene (FEP), perfluoromethylvinyl ether (MFA), acrylic resins, silicone resins, ethylene-vinyl acetate (EVA), polyurethane dispersions (PUD), polyvinyl alcohol (PVOH) resins, polyvinylidine difluoride (PVDF) resins, polyvinyldichloride (PVDC) resins, polyetheretherketone (PEEK) resins, polyamideimide (PAI) resins, polyarylsulfone (PAS) resins, epoxy resins, polyester resins, polyvinyl chloride (PVC) resins, and melamine-formaldehyde resins.

In another form thereof, the present disclosure provides a method of treating a textile article, including the steps of: providing a substrate comprising a mineral fiber; applying a treatment composition to the substrate, the treatment composition including: at least one fluoropolymer; and at least one co-resin different than the at least one fluoropolymer, the at least one co-resin selected from the group consisting of fluorinated ethylene-propylene (FEP), perfluoromethylvinyl ether (MFA), acrylic resins, silicone resins, ethylene-vinyl acetate (EVA), polyurethane dispersions (PUD), polyvinyl alcohol (PVOH) resins, polyvinylidine difluoride (PVDF) resins, polyvinyldichloride (PVDC) resins, polyetheretherketone (PEEK) resins, polyamideimide (PAI) resins, polyarylsulfone (PAS) resins, epoxy resins, polyester resins, polyvinyl chloride (PVC) resins, and melamine-formaldehyde resins; and curing the treatment composition.

### BRIEF DESCRIPTION OF THE DRAWINGS

The above-mentioned and other features and advantages of this disclosure, and the manner of attaining them, will become more apparent and the disclosure itself will be better understood by reference to the following description of embodiments of the disclosure taken in conjunction with the accompanying drawings, wherein:

FIG. 1 is a perspective view of sleeve made of basalt fiber, the sleeve having a knit body folded onto itself and received on an exhaust pipe;

FIGS. 2A-2E correspond to Example 1, wherein:

FIG. 2A shows the results of the stone impingement test on an untreated sleeve that was not heat aged;

FIG. 2B shows the results of the stone impingement test on a first untreated sleeve that was subjected to heat aging;

FIG. 2C shows the results of the stone impingement test on a second untreated sleeve that was subjected to heat aging;

FIG. 2D shows the results of the stone impingement test on a first treated sleeve that was subjected to heat aging, the left side of the figure including a photograph showing the folded sleeve, and the right side of the figure including a photograph of the unfolded sleeve, where the left side of the photograph shows the inner, untreated portion of the folded sleeve, and the right side of the photograph shows the outer, treated portion of the folded sleeve;

FIG. 2E shows the results of the stone impingement test on a second treated sleeve that was subjected to heat aging, the left side of the figure including a photograph showing the folded sleeve, and the right side of the figure including a photograph of the unfolded sleeve, where the left side of the photograph shows the outer, treated portion of the folded sleeve, and the right side of the photograph shows the inner, untreated portion of the folded sleeve;

FIGS. 3A and 3B correspond to Example 2, wherein:

FIG. 3A shows the results of the stone impingement test on a first treated sleeve that was subjected to heat aging, the left side of the figure including a photograph showing the folded sleeve, and the right side of the figure including a photograph showing the folded sleeve cut between the treated and untreated portions, with the outer treated portion also cut longitudinally and opened, positioning the inner treated portion within the outer treated portion;

FIG. 3B shows the results of the stone impingement test on a second treated sleeve that was subjected to heat aging, the left side of the figure including a photograph showing the folded sleeve, and the right side of the figure including a photograph showing the folded sleeve cut between the treated and untreated portions, with the outer treated portion also cut longitudinally and opened, positioning the inner treated portion within the outer treated portion;

FIGS. 4A and 4B correspond to Example 3, wherein:

FIG. 4A shows the results of the stone impingement test on a first treated sleeve that was subjected to heat aging, the left side of the figure including a photograph showing the folded sleeve, and the right side of the figure including a photograph showing the folded sleeve cut between the treated and untreated portions, with the outer treated portion also cut longitudinally and opened, positioning the inner treated portion within the outer treated portion;

FIG. 4B shows the results of the stone impingement test on a second treated sleeve that was subjected to heat aging, the left side of the figure including a photograph showing the folded sleeve, and the right side of the figure including a photograph showing the folded sleeve cut between the treated and untreated portions, with the outer treated portion also cut longitudinally and opened, positioning the inner treated portion within the outer treated portion;

FIGS. 5A and 5B correspond to Example 4, wherein:

FIG. 5A shows the results of the stone impingement test on a first treated sleeve that was subjected to heat aging, where a sleeve folded over and used for testing has been unfolded and split longitudinally, and the left side of the photograph shows the coated outer portion and the right side of the photograph shows the uncoated inner portion of the sleeve, and where the top half of the figure indicates a first stone impingement test conducted on one side of the folded sleeve, and the bottom half of the figure indicates a second stone impingement test conducted on an opposite side of the folded sleeve;

FIG. 5B shows the results of the stone impingement test on a second treated sleeve that was subjected to heat aging, where a sleeve folded over and used for testing has been unfolded and split longitudinally, and the left side of the photograph shows the coated outer portion and the right side of the photograph shows the uncoated inner portion of the sleeve, and where the top half of the figure indicates a first stone impingement test conducted on one side of the folded sleeve, and the bottom half of the figure indicates a second stone impingement test conducted on an opposite side of the folded sleeve;

FIGS. 6A and 6B correspond to Example 5, wherein:

FIG. 6A shows the results of the stone impingement test on a first treated sleeve that was subjected to heat aging, where a sleeve folded over and used for testing has been unfolded and split longitudinally, and the left side of the photograph shows the coated outer portion and the right side of the photograph shows the uncoated inner portion of the sleeve, and where the top half of the figure indicates a first stone impingement test conducted on one side of the folded sleeve, and the bottom half of the figure indicates a second stone impingement test conducted on an opposite side of the folded sleeve;

FIG. 6B shows the results of the stone impingement test on a second treated sleeve that was subjected to heat aging, where a sleeve folded over and used for testing has been unfolded and split longitudinally, and the left side of the photograph shows the coated outer portion and the right side of the photograph shows the uncoated inner portion of the sleeve, and where the top half of the figure indicates a first stone impingement test conducted on one side of the folded sleeve, and the bottom half of the figure indicates a second stone impingement test conducted on an opposite side of the folded sleeve;

FIGS. 7A and 7B correspond to Example 6, wherein:

FIG. 7A shows the results of the stone impingement test on a first treated sleeve that was subjected to heat aging, where a sleeve folded over and used for testing has been unfolded and split longitudinally, and the left side of the photograph shows the coated outer portion and the right side of the photograph shows the uncoated inner portion of the sleeve, and where the top half of the figure indicates a first stone impingement test conducted on one side of the folded sleeve, and the bottom half of the figure indicates a second stone impingement test conducted on an opposite side of the folded sleeve; and

FIG. 7B shows the results of the stone impingement test on a second treated sleeve that was subjected to heat aging, where a sleeve folded over and used for testing has been unfolded and split longitudinally, and the left side of the photograph shows the coated outer portion and the right side of the photograph shows the uncoated inner portion of the sleeve, and where the top half of the figure indicates a first stone impingement test conducted on one side of the folded sleeve, and the bottom half of the figure indicates a second stone impingement test conducted on an opposite side of the folded sleeve.

Corresponding reference characters indicate corresponding parts throughout the views. The exemplifications set out herein illustrate embodiments of the disclosure, and such exemplifications are not to be construed as limiting the scope of the disclosure in any manner.

### DETAILED DESCRIPTION

The present disclosure relates to the treatment of textile articles, such as sleeves made of mineral fibers of the type that are used with automotive exhaust system components, by impregnating the textile articles with treatment compositions of various formulations including fluoropolymers and/or mixtures of fluoropolymers with co-resins, followed by heat treatment to cure the compositions, thereby providing protection against impact damage to the sleeve. The treatment serves to impart enhanced resistance to damage of the sleeve by holding the overall fibrous structure of the sleeve together during impact such as by stone impingement, even if underlying fibers themselves are broken or damaged. The treatment composition may, in some embodiments, impregnate and fill some or all of the interstitial spaces between the fibers of the textile article.

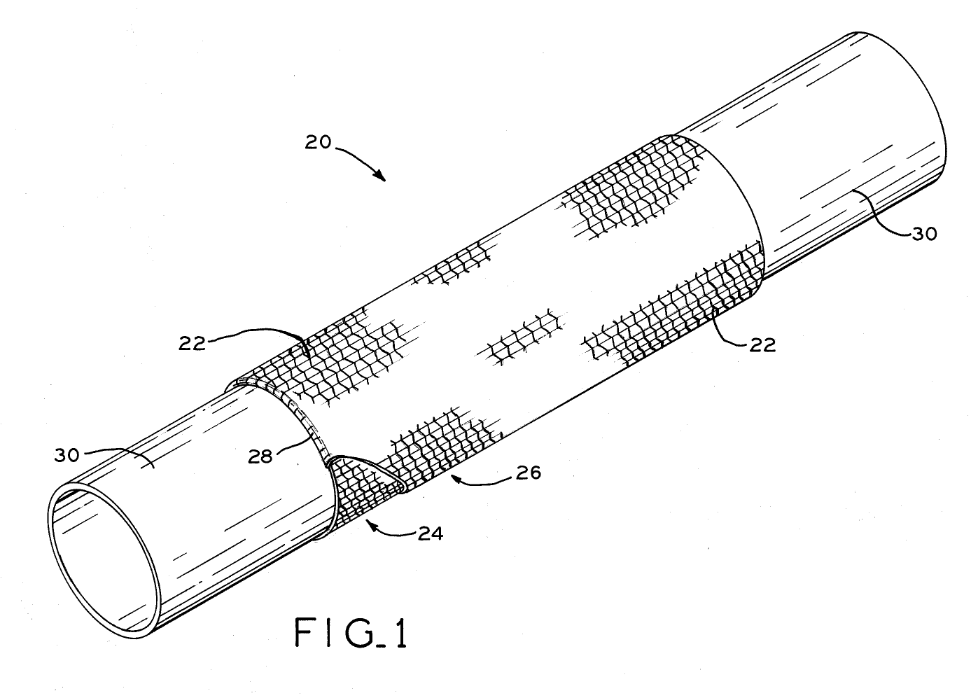

Referring to FIG. 1, an exemplary sleeve 20 is shown, which is made of textiles and/or fibers of the type treatable with the present method. Sleeve 20 has a body with a generally tubular shape, and is formed of a knit textile or fiber 22 such as high heat resistant material including mineral fibers such as silica, ceramics, basalt, fiberglass, aramid, or carbon, for example. The mineral fibers may be provided in the form of a weave of multifilament yarns, for example. In one embodiment, the tubular sleeve 20 is made of knit basalt fibers, and is folded onto itself to form inner and outer layers 24 and 26, respectively, about a fold 28. In one exemplary application, the sleeve 20 may be fitted around a component of a vehicular exhaust system, such as an exhaust pipe 30, as shown in FIG. 1.

The treatment provided to sleeve 20 in accordance with the present process provides impact damage resistance while also being highly heat resistant, and is able to withstand, for example, temperatures ranging from at least 200° C., at least 350° C., or at least 400° C., to at least to 450° C. or more, or within any range delimited by these values.

As described below, the sleeve and its knitted fibers may be treated with a treatment composition in accordance with the present disclosure, which impregnates and/or coats the fibers of the treated article. In an embodiment, the treatment composition may fill some or all of the interstitial spaces between the fibers of the treated article. In one embodiment, the composition is distributed over both the inner and outer layers of the sleeve, i.e., the entire sleeve is treated with the composition. In another embodiment, the composition is distributed over only the outer layer, i.e., only half of the sleeve is treated with the composition, whereby the sleeve is then folded onto itself as shown in FIG. 1 such that the treated layer is formed on the exposed outer layer of the sleeve. The treatment in accordance with the present disclosure provides enhanced impact damage resistance as described in connection with the Examples below.

The treatment composition is applied in liquid form, and generally includes at least one fluoropolymer, or a mixture of at least one fluoropolymer and at least one co-resin. Typically, the co-resin will be different from the fluoropolymer.

Suitable fluoropolymers include, but are not limited to, polytetrafluoroethylene (PTFE), co-polymers of tetrafluoroethlyene and ethylene (ETFE), co-polymers of tetrafluoroethylene and hexafluoropropylene (FEP), co-polymers of tetrafluoroethylene and perfluorovinylether (PFA), co-polymers of tetrafluoroethylene and perfluoromethylvinyl ether (MFA) and polyvinylidene fluoride (PVDF), and co-polymers of tetrafluoroethylene, hexafluoropropylene, and vinylidene difluoride (THV), and other perfluorinated polymers. It is recognized that other fluoropolymer compositions are also within the scope of the disclosure. The fluoropolymer is typically provided in the form of a liquid dispersion, such as an aqueous dispersion. The fluoropolymer is highly heat-resistant, and is also thought to provide the main component of damage resistance to the treated fibrous material.

In most embodiments, a medium or high molecular weight PTFE is used, for example, a PTFE having a number average molecular weight (Mₙ) of at least 250,000, at least 500,000, at least 1,000,000, or at least 5,000,000 or more, or within any range delimited by these values. One suitable PTFE is D-310, available from Daikin America, Inc.

Co-resins that may be used in the present process include other fluoropolymers, including those described above, such as fluorinated ethylene-propylene (FEP), methylfluoroalkoxy (MFA), as well as other non-fluoropolymer resins, such as acrylic resins, silicone resins, ethylene-vinyl acetate (EVA), polyurethane dispersions (PUD), polyvinyl alcohol (PVOH) resins, polyvinylidine difluoride (PVDF) resins, polyvinyldichloride (PVDC) resins, polyetheretherketone (PEEK) resins, polyamideimide (PAI) resins, polyarylsulfone (PAS) resins, epoxy resins, polyester resins, polyvinyl chloride (PVC) resins, melamine-formaldehyde resins, and other suitable polymeric resins that can either be dispersed or dissolved in water.

While the use of waterborne systems is typically desired to reduce or eliminate volatile organic compounds (VOC's), it is recognized that solvent-borne resin systems and/or the use of co-solvents are within the scope of the present disclosure. The co-resin can perform a variety of functions including improving the processability of the composition. For example, a melt-processible fluoropolymer co-resin such as FEP, PFA, or MFA may be softer and/or more extensible than the fluoropolymer such as PTFE, and so including a melt-processible fluoropolymer co-resin may allow for a greater extensibility and/or softness of the coating. Non-fluoropolymer co-resins may provide areas of discontinuity within the coating, which may permit an increased amount of deformation of the sintered particle matrix of the fluoropolymer such as PTFE. Certain co-resins, for example silicone-containing co-resins, impart improved heat-aging properties to the treatment compositions. In applications where extreme heat stability is not critical, the use of a non-fluoropolymer-based co-resin may make the treatment more economical to produce and/or apply.

Suitable silicone resins that may be used include polysiloxanes having the following structure:

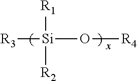

wherein X indicates the number of repeating units, and may be from 5 to 1000. R₁ and R₂ may be different functional groups, or the same functional group, and may be alkyl, aryl, alkoxyalkyl, alkoxyaryl, or hydroxyalkyl groups. R₃ and R₄ may be different terminal groups, or may be the same terminal group, and may include hydroxy, alkyl, aryl, or hydroxyalkyl groups.

In some embodiments, R₃ and R₄ are non-amino groups, wherein the polysiloxane is non-amino terminated. One suitable silicone resin is methylphenylpolysiloxane, such as Silikophen® P 40/W, available from Evonik Tego Chemie GmbH (Silikophen® is a registered trademark of Evonik Goldschmidt GmbH).

In some embodiments, the treatment composition will include only fluoropolymers, i.e., will include one or more fluoropolymers with no co-resin(s).

In embodiments that do not include only fluoropolymers, but rather include at least one fluoropolymer together with at least one co-resin, the amount of the fluoropolymer(s) may be as little as 50, 75, or 80 wt. %, or as great as 85, 90, or 95 wt. % of the weight of the treatment composition, and the amount of the co-resin may be as little as 5, 10, or 15 wt. %, or as great as 20, 25, or 50 wt. % of the weight of the treatment composition, or within any range encompassed by the foregoing values, based on the combined solids content of the fluoropolymer(s) and co-resin(s).

The following is a description of an exemplary process by which a textile or fibrous article, such as sleeve 20, may be treated in accordance with the present disclosure.

Formulated liquid treatment compositions or formulations are prepared via simple blending of the constituent materials in predetermined ratios using propeller or impeller mixers driven with an air motor, for example.

Liquid treatment compositions are prepared to achieve a target amount or a target range of deposition weights on the treated article, via control of the amount of non-volatiles (solids) present in the treatment composition, and is expressed herein as a weight percent based on the weight of the coated portion of the treated article (basis weight). Thus, the weight of the coated portion of the treated article may not include the weight of the entire article, if portions of the article are not coated. For example, if one half of a sleeve is treated, then the basis weight may include the one half of the sleeve that is treated.

Specifically, determination of the amount of treatment composition applied is made by subtraction of the weight of the article in the untreated state from the article in the treated state, following drying and curing of the treatment composition.

The treatment deposition weight, in the dried and cured state, may be as little as 5, 10, or 20 wt. %, or as great as 50, 75, or 100 wt. % of the basis weight of the article. In one embodiment, the deposition weight is between 25 to 40% of the basis weight of the article.

Application of the liquid treatment composition to the substrate may be accomplished by full immersion of the substrate into a reservoir containing the liquid treatment composition, of the portion of the article that is to be treated, followed by passing the article through (between) a pair of nip rollers in order to remove excess liquid to thereby consistently control the amount of liquid being applied, and to reduce the amount of liquid on the article to a level at which migration of the applied liquid from one region to another is minimized, resulting in a more uniform application of the treatment composition.

Following removal of excess liquid, any volatiles are removed from the treated article by accelerated drying in a forced-air oven, typically at a first, relatively lower temperature of 85 to 105° C. for a hold time of 5 to 15 minutes.

Following drying, the article is transferred to a second oven for the cure process, typically at a second, relatively higher temperature of 344 to 432° C. (650 to 810° F.), most commonly at 400° C. (750° F.), for a hold time of 5 to 15 minutes, most commonly 10 minutes.

Following curing, the article is removed from the oven and allowed to cool to room temperature.

In cases where the treated and cured article has lost a high degree of its flexibility, some manually forced flexing of the treated portion of the article is employed to loosen the article. The flexing may be accomplished either before or after the article is cooled to room temperature.

### EXAMPLES

The following Examples illustrate exemplary methods and characteristics of the present disclosure, which is not to be construed as limited thereto. Weight percentages in the Examples are based on total solids of material unless otherwise indicated.

### Materials, Methods, and Equipment

Heat conditioning/aging. The treated sleeves may be subjected to a heat conditioning or heat aging test, described below. In the majority of cases in the present Examples, durability testing was carried out on articles that had been exposed to typical “in use” temperatures for a period of time after treatment, in order to simulate potential deterioration of the treatment and its resultant durability due to thermal exposure in actual use.

The heat conditioning was performed in forced-air ovens, with the article installed on a shell metal tube of a diameter similar to the intended application, with the tube having a length long enough to support the entire test sleeve. The tube was inserted into and through the sleeve, with enough of the tube protruding from each end of the sleeve so that the tube was supported in the oven in a horizontal orientation. In cases where the test piece was a fully constructed sleeve that had been treated along one-half of its length, the sleeve was arranged on the tube in a ‘doubled-over’ configuration, with the un-treated portion of the sleeve against the tube and the treated portion surrounding the un-treated portion, in order to best simulate how the sleeve would be oriented during actual use. In the case of sleeves which were treated in their entirety, a second un-treated sleeve was placed on the metal tube first, and the treated sleeve placed around the untreated one.

Durability testing. Durability testing was evaluated on a stone impingement apparatus called a “Gravelometer” made by Q-Lab Corporation of Westlake, Ohio. This test procedure is detailed in ASTM D3170-03(2007), Standard Test Method for Chipping Resistance of Coatings, and SAE J400, Test for Chip Resistance of Surface Coatings. Essentially, a standardized volume of smooth stones of standardized sizes was introduced into the Gravelometer. A stream of stones were then accelerated toward the test target by introducing the stones into a stream of compressed air over a prescribed time period which was directed at the test piece.

For the purpose of testing the durability of the treated sleeves, the sleeves were mounted on a metal tube (aluminum or steel) in the same manner as used for heat conditioning the sleeves. The metal tube was then mounted inside the Gravelometer in a horizontal orientation directly in the path of the compressed air stream. In all cases, the sleeves were tested in the ‘doubled-over’ manner, resulting in the test piece being two layers of fabric over the metal tube. The treated portion of the sleeve is on the outside to absorb the direct impact of the stones, and the untreated portion of the sleeve is against the metal tube.

Evaluation of the test results is by visual examination. Typically, comparison to un-treated control test articles, or comparison of one treatment composition formula to another, is used to assess the effectiveness of the treatment.

Materials. Tubular knit sleeves constructed from basalt yarns were tested. The lengths, diameters, knit patterns, and densities of the sleeves varied. Materials of the treatment compositions are set forth in Table 1 below.

TABLE 1
Materials of the Treatment Compositions

| | | Product | |
|---|---|---|---|
| Component | Type | Designation | Manufacturer |
| Fluoropolymer | PTFE | D-310 | Daiken America, |
| Dispersions | | | Inc. |
| | | SFN-C01 | Chenguang |
| | | TF5035Z | Dyneon |
| | FEP | TE7224 | DuPont |
| | | TE9586 | DuPont |
| | | 6300GZ | Dyneon |
| | MFA | D5220X | Solvay |
| Binder Resins | Acrylic | A081W | DSM Neoresins |
| | M-P | Silikophen ® | Evonik Tego |
| | | P 40/W | Chemie |
| | Polysiloxane | | GmbH |
| | Polyamideimide | D2376 | Whitford |

The liquid treatment compositions were applied with a lab-scale “pad,” a driven squeeze nip consisting of SS lower roll and rubber-covered plain steel upper roll. The lab ovens used were “Blue-M” forced-air electrically heated box ovens of the type available from Thermal Product Solutions, a division of SPX.

### Example 1

Half of two basalt sleeves were treated as described above using a PTFE dispersion (TF 5035Z; Dyneon) to achieve two levels of pick-up weight on the basalt fibers, 34 wt. % and 15 wt. %, respectively. These sleeves, along with an untreated control sleeve were heat conditioned at 350° C. for two hours. The sleeves were mounted on the test pipe and then doubled-over on themselves so the treated halves of the sleeves were on the outside and the untreated halves on the inside against the pipe. The untreated control sleeve was also folded over itself in the same manner. The sleeves were then placed in the Gravelometer and exposed to equal durations of stone impingement. They were then taken out of the Gravelometer, unfolded, and the extent of damage to the treated section (outside) evaluated. Damage to the inside of the sleeve (untreated) was also evaluated.

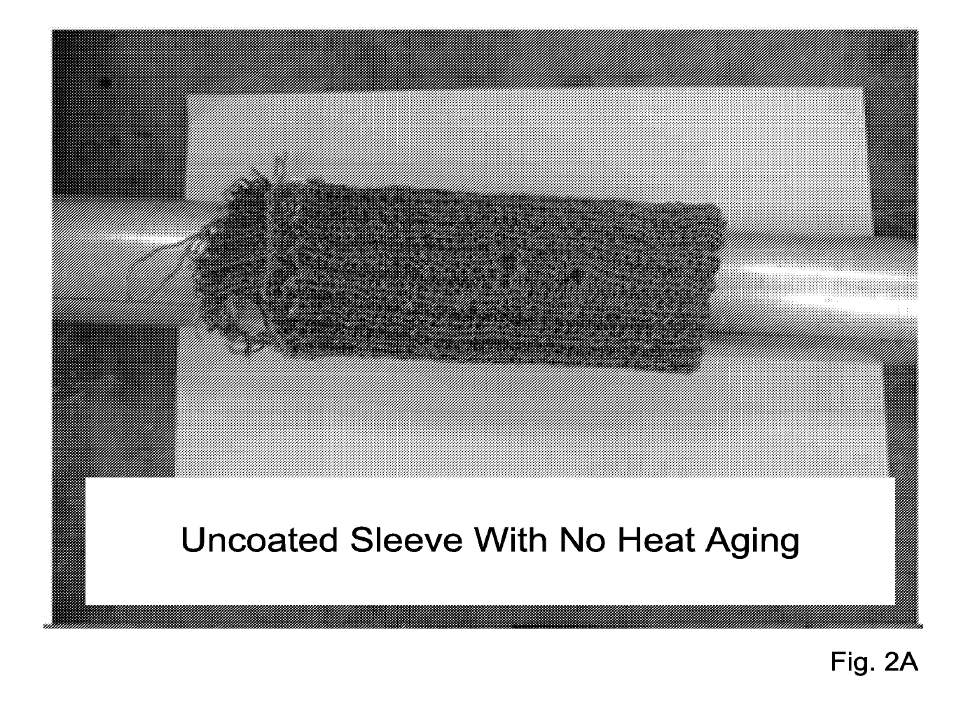

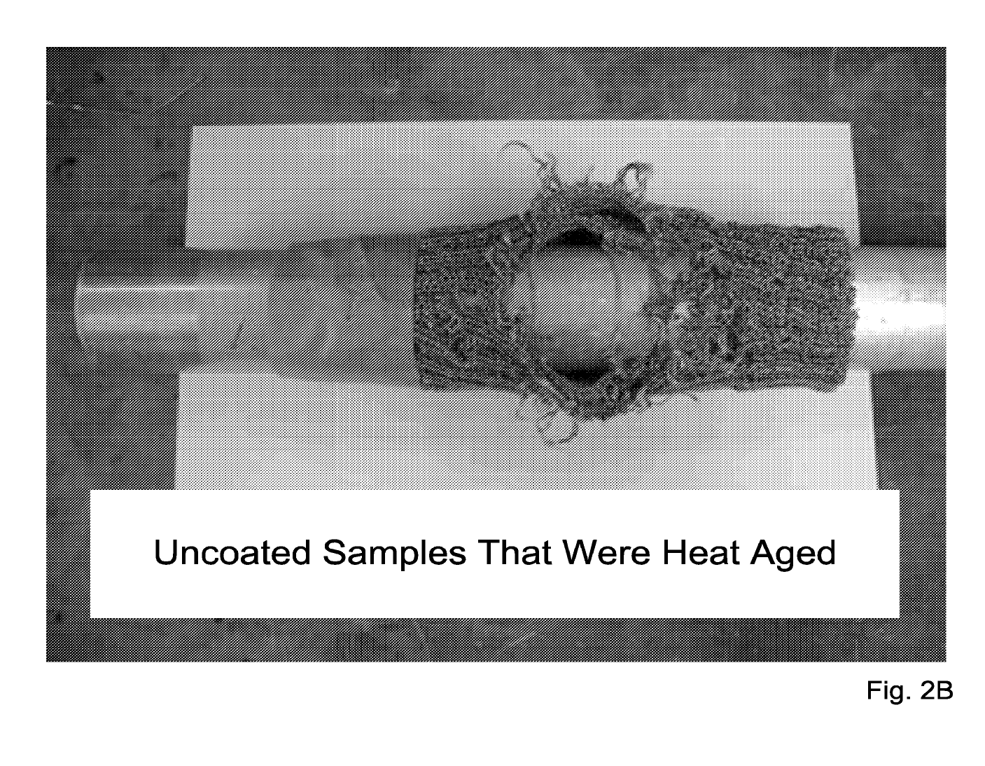

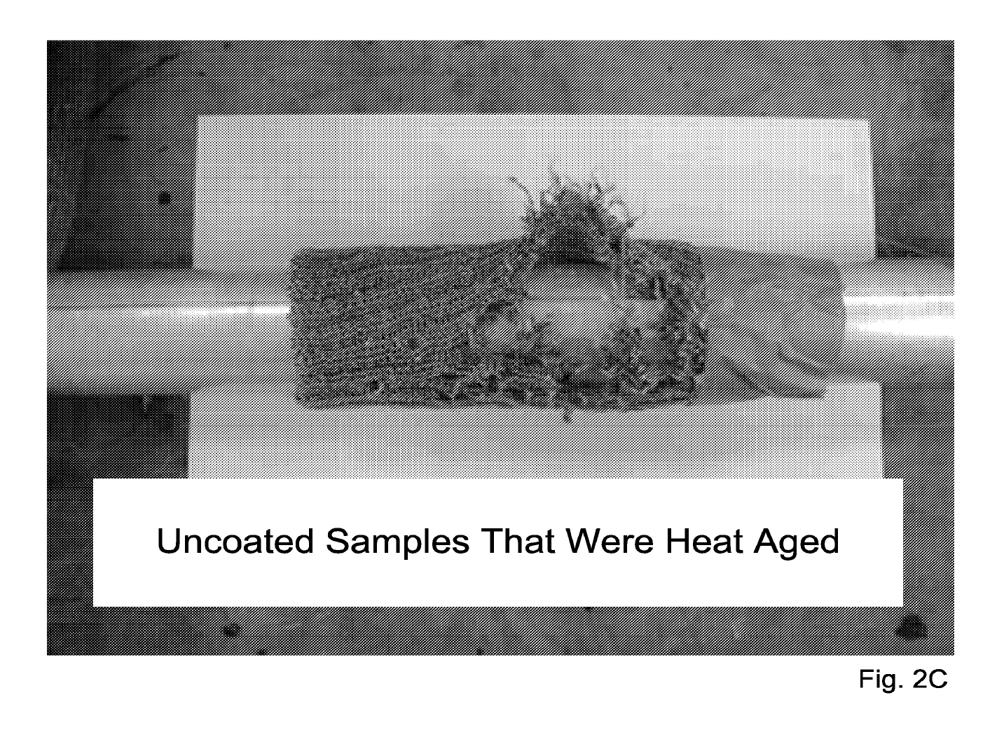

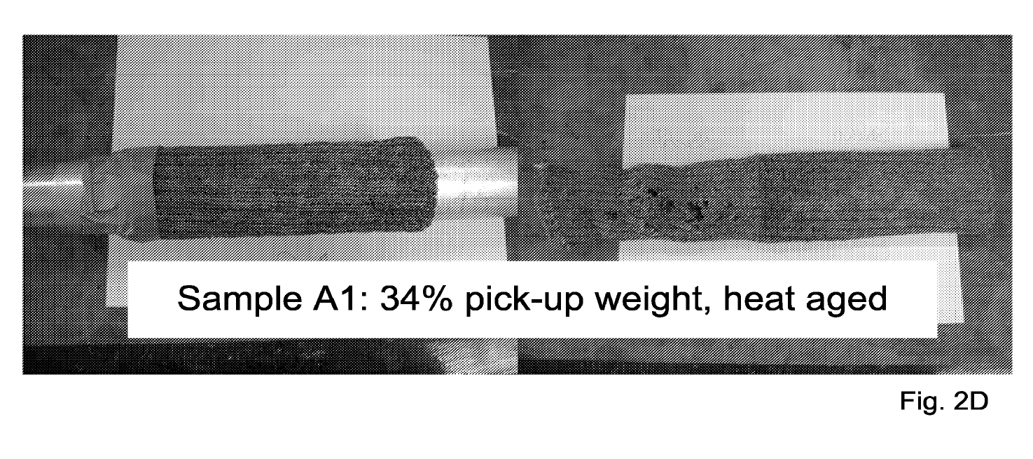

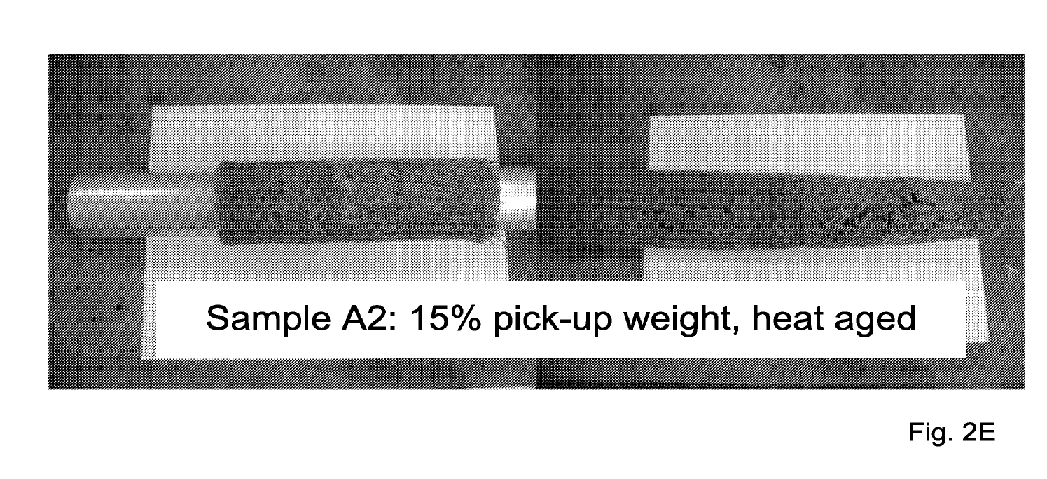

FIGS. 2A-C show the result of the stone impingement test on the untreated, control samples. As can be observed from FIGS. 2B and 2C, there is total destruction of both layers of the article. Of note, as shown in FIG. 2A, if the control (untreated) sleeve is not heat aged, it has much better stone impingement resistance than the heat aged control samples. It is known that the heat-aging of the untreated sleeve greatly reduces its durability or resistance to damage by stone impingement, but the mechanism of this is unknown. FIGS. 2D and 2E show the result of the stone impingement test on the treated sleeves at 34 wt. % pickup and 15 wt. % pickup, respectively, with these samples showing a much better resistance than the control samples of FIGS. 2B and 2C. FIGS. 2A, 2B, and 2C show the sleeve folded in on itself, with the coated outer portion of the sleeve surrounding the uncoated inner portion. FIG. 2D shows the results of the stone impingement test on a first treated sleeve that was subjected to heat aging, the left side of the figure including a photograph showing the folded sleeve, and the right side of the figure including a photograph of the unfolded sleeve, where the left side of the photograph shows the inner, untreated portion of the folded sleeve, and the right side of the photograph shows the outer, treated portion of the folded sleeve. FIG. 2E shows the results of the stone impingement test on a second treated sleeve that was subjected to heat aging, the left side of the figure including a photograph showing the folded sleeve, and the right side of the figure including a photograph of the unfolded sleeve, where the left side of the photograph shows the outer, treated portion of the folded sleeve, and the right side of the photograph shows the inner, untreated portion of the folded sleeve.

### Example 2

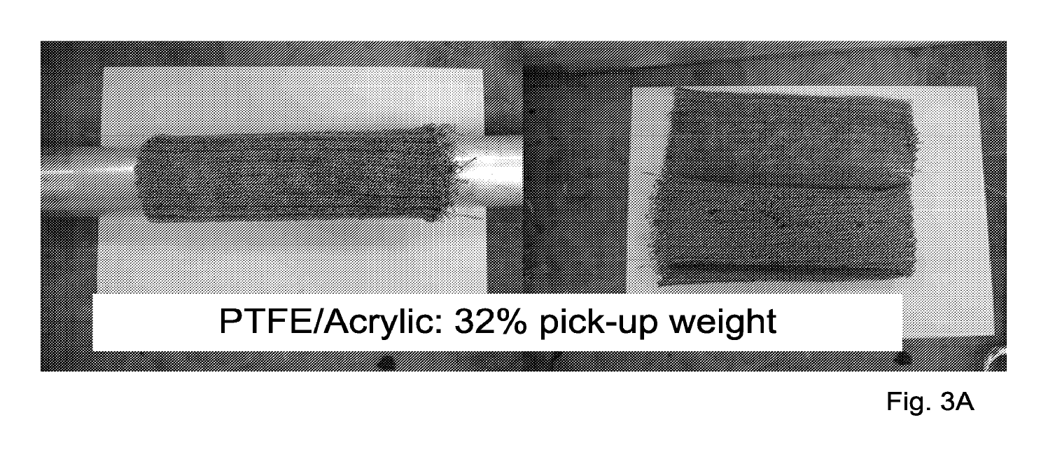

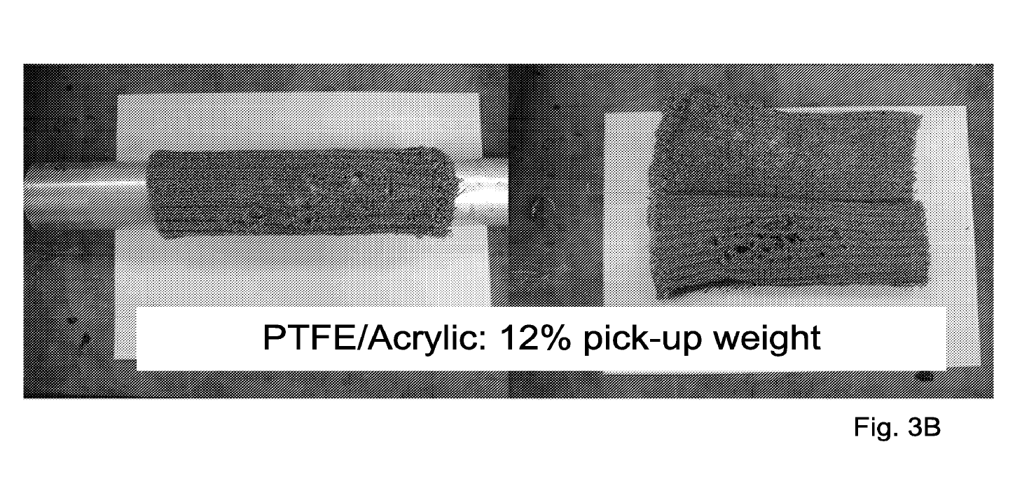

The same procedure as in Example 1 was used utilizing a blend of 88 wt. % PTFE dispersion (TF 5035Z) and 12 wt. % of an acrylic dispersion (DSM AO81W) at 32 wt. % and 12 wt. % pick-up weights. The results of the stone impingement test are shown in FIGS. 3A and 3B. In both FIGS. 3A and 3B, the photograph on the left side of the figure shows the sleeve folded over on itself, with the treated outer portion surrounding the untreated inner portion, and the right side of the figure including a photograph showing the folded sleeve cut between the treated and untreated portions, with the outer treated portion also cut longitudinally and opened, positioning the inner treated portion within the outer treated portion, showing the inside of the outer treated portion (top), and the outside of the inner untreated portion of the sleeve (bottom).

### Example 3

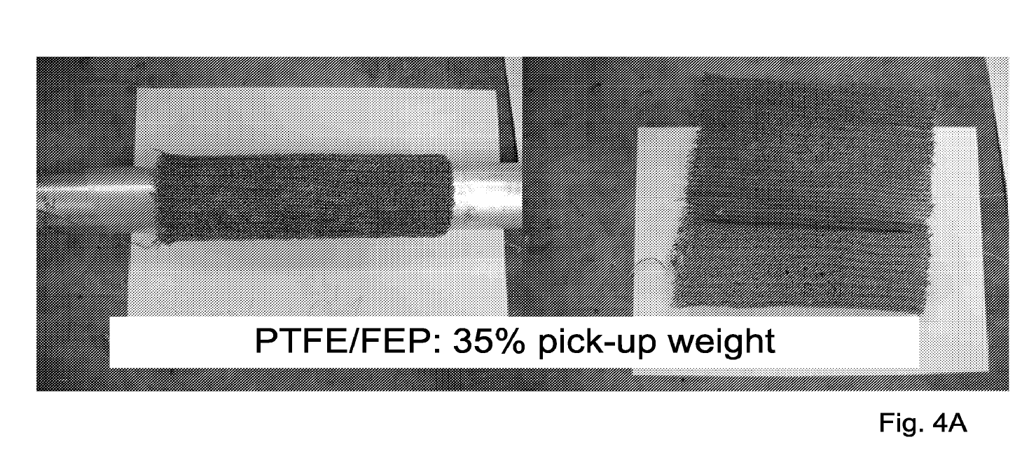

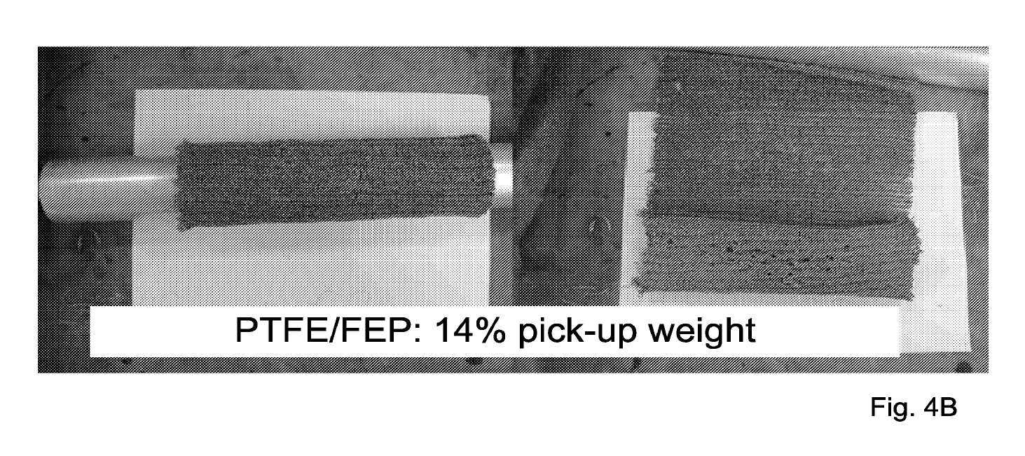

The same procedure as in Example 1 was used utilizing a blend of 78 wt. % PTFE dispersion (TF 5035Z) and 22 wt. % of FEP dispersion (Dyneon 6300GZ) at pickup weights of 35 wt. % and 14 wt. %. The results of the stone impingement test are shown in FIGS. 4A and 4B. In both FIGS. 4A and 4B, the photograph on the left side of the figure shows the sleeve folded over on itself, with the treated outer portion surrounding the untreated inner portion, and the right side of the figure including a photograph showing the folded sleeve cut between the treated and untreated portions, with the outer treated portion also cut longitudinally and opened, positioning the inner treated portion within the outer treated portion, showing the inside of the outer treated portion (top), and the outside of the inner untreated portion of the sleeve (bottom).

### Example 4

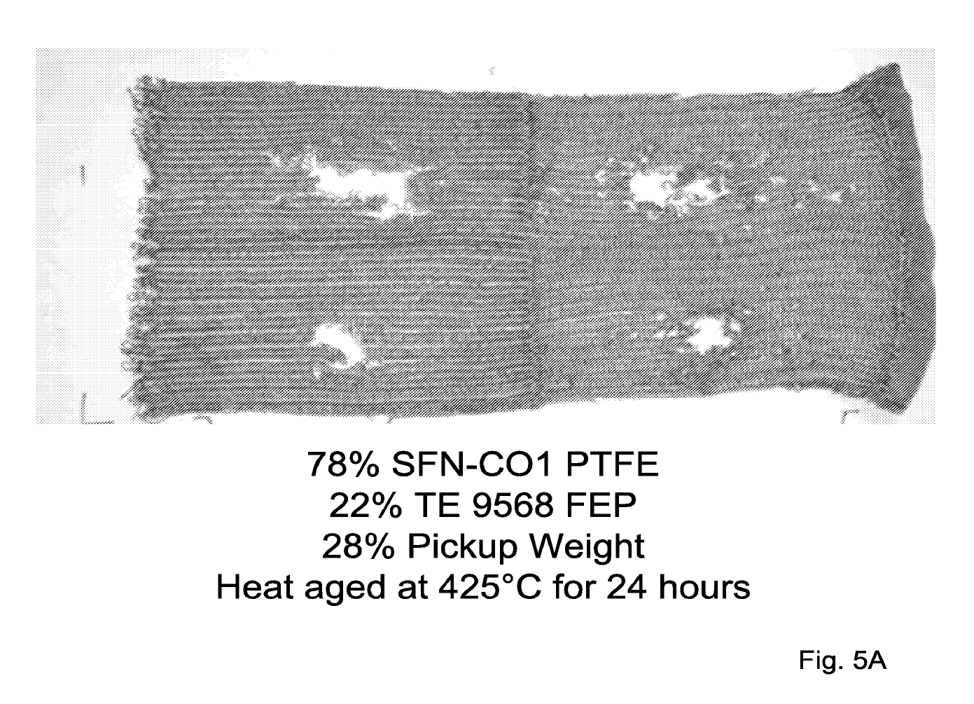

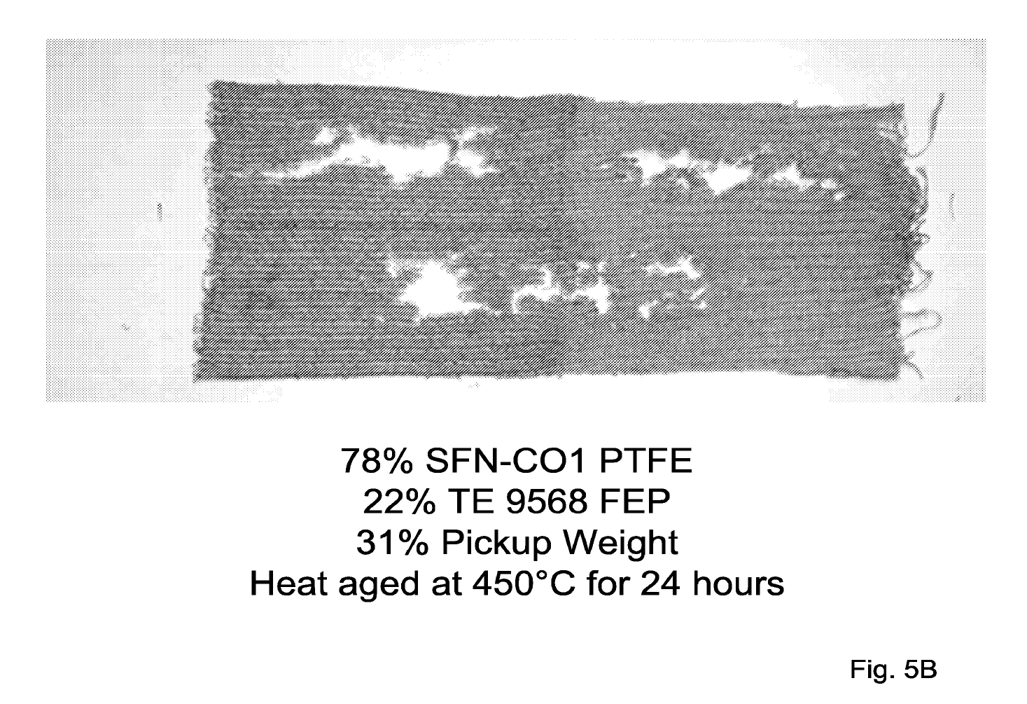

The formulation of Example 3 was used with an alternative PTFE dispersion, SFN-CO1 (from Chenguang Technical Institute) and an alternative FEP. The same procedure as in Example 1 was used utilizing a mixture of 78 wt. % SFN-CO1 (PTFE) and 22 wt. % TE 9568 (FEP). The treated sleeves were then heat conditioned at 425° C. and at 450° C. for 24 hours, then subjected to the stone impingement test. The results are presented in FIG. 5A and 5B. In FIGS. 5A and 5B, a sleeve has been folded over and used for two stone impingement tests. The sleeve is shown unfolded and split longitudinally, and the left side of the photograph shows the coated outer portion and the right side of the photograph shows the uncoated inner portion of the sleeve, where the top half of the figure indicates a first stone impingement test conducted on one side of the folded sleeve, and the bottom half of the figure indicates a second stone impingement test conducted on an opposite side of the folded sleeve.

In these pictures, the socks have been unfolded and have been cut or split longitudinally. The right is the untreated half and the left is the treated half. As can be seen from the pictures, the high-temperature heat conditioning compromises the protective nature of this particular treatment versus the results seen at the two hour heat aging at 350° C. Shown in FIGS. 2B and 2C, the degree of damage incurred by an untreated article subjected to 350° C. for two hours is severe. FIG. 5A shows undesirable damage to the coated area after heat conditioning, but less damage than a similarly heat conditioned untreated sock as shown in FIGS. 2B and 2C. The process of heat conditioning (or aging) is known to diminish the durability of the article. This is true regardless of whether it is treated or not, or which coating composition is used. The degree of such diminishment may include many factors, including the specific coating composition used to treat the article, the amount of the coating applied, and the time and temperature of the heat conditioning.

### Example 5

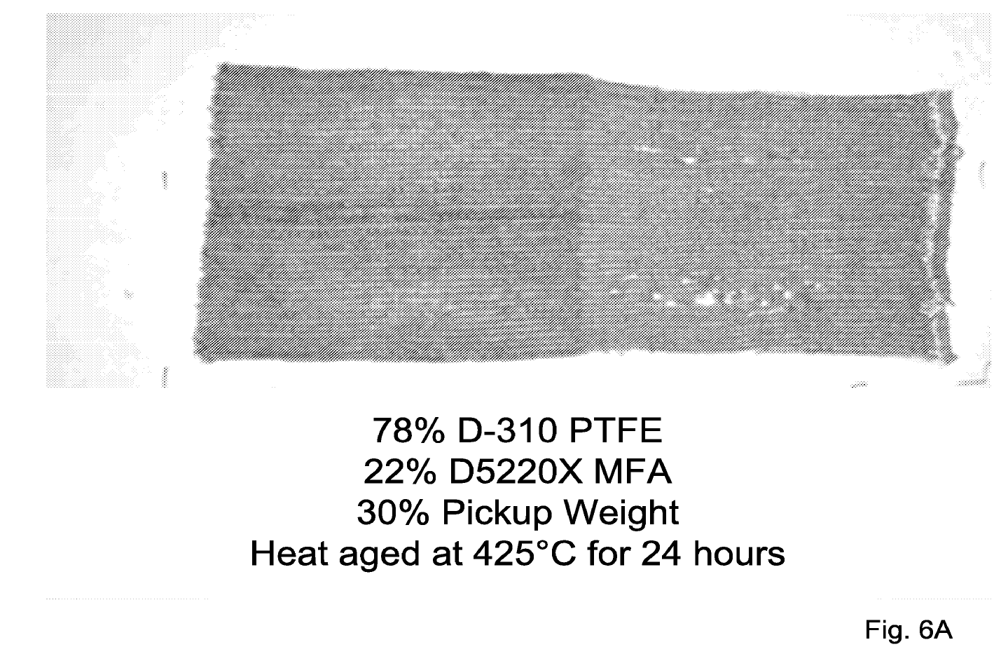

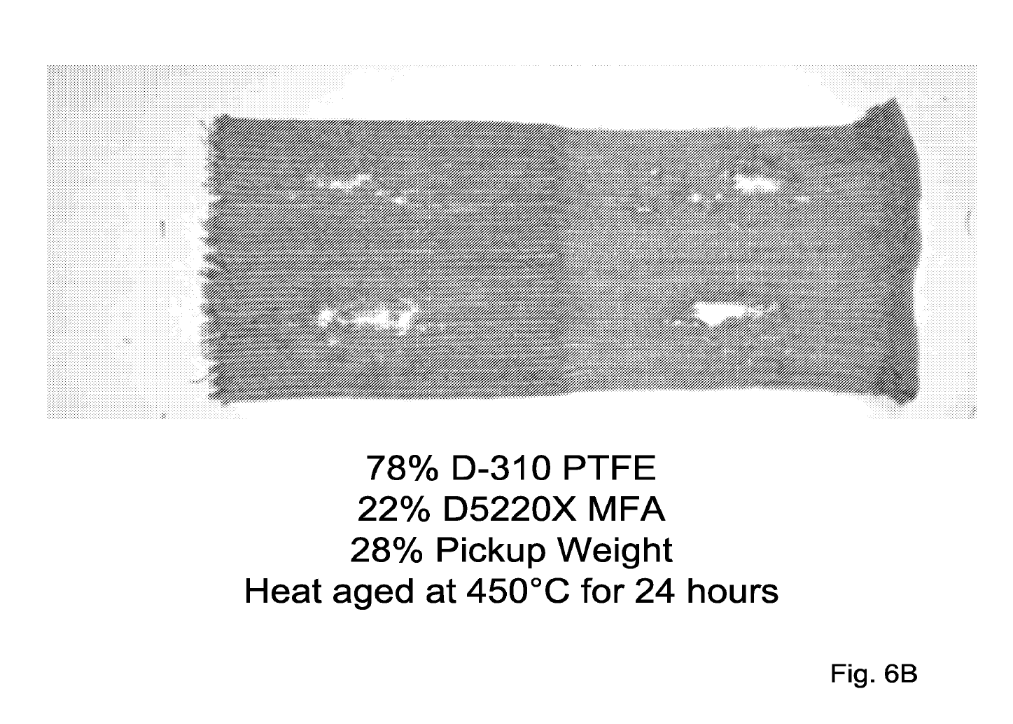

The same procedure as in Example 4 was used to prepare and test sleeves using a formulation consisting of 78 wt. % PTFE dispersion (Daiken D-310) and 22 wt. % MFA dispersion (Solvay D5220X). Results are shown in FIGS. 6A and 6B, showing an improvement in the results obtained relative to the results in Example 4 by using a combination of a high molecular weight PTFE (D-310) and MFA. In FIGS. 6A and 6B, a sleeve has been folded over and used for two stone impingement tests. The sleeve is shown unfolded and split longitudinally, and the left side of the photograph shows the coated outer portion and the right side of the photograph shows the uncoated inner portion of the sleeve, where the top half of the figure indicates a first stone impingement test conducted on one side of the folded sleeve, and the bottom half of the figure indicates a second stone impingement test conducted on an opposite side of the folded sleeve.

### Example 6

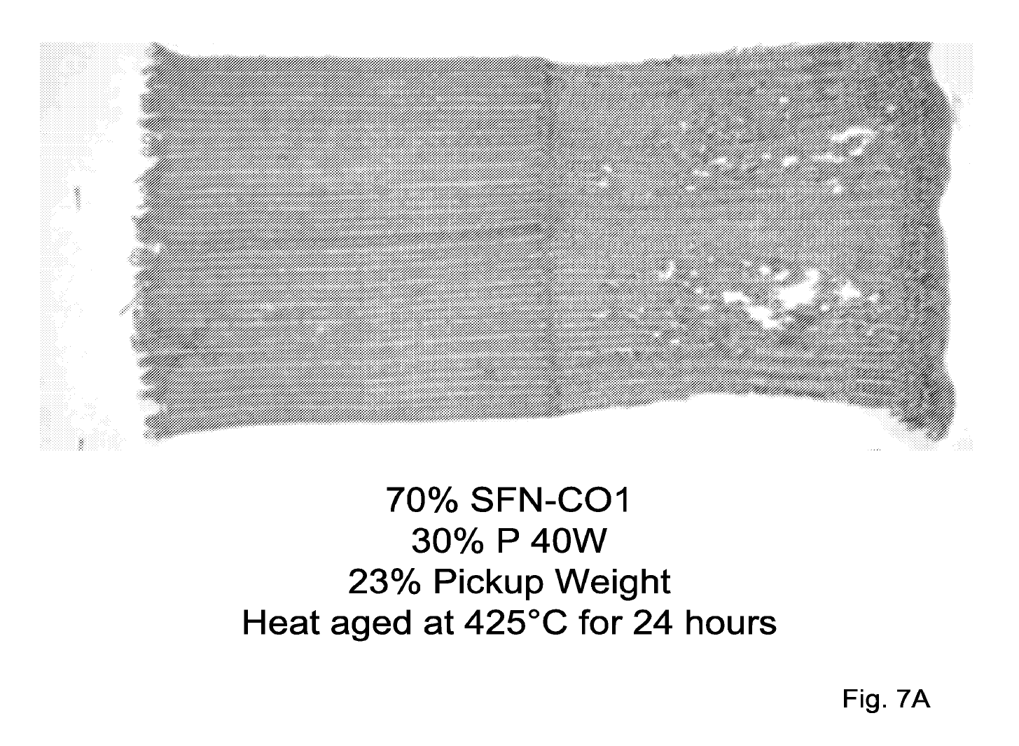

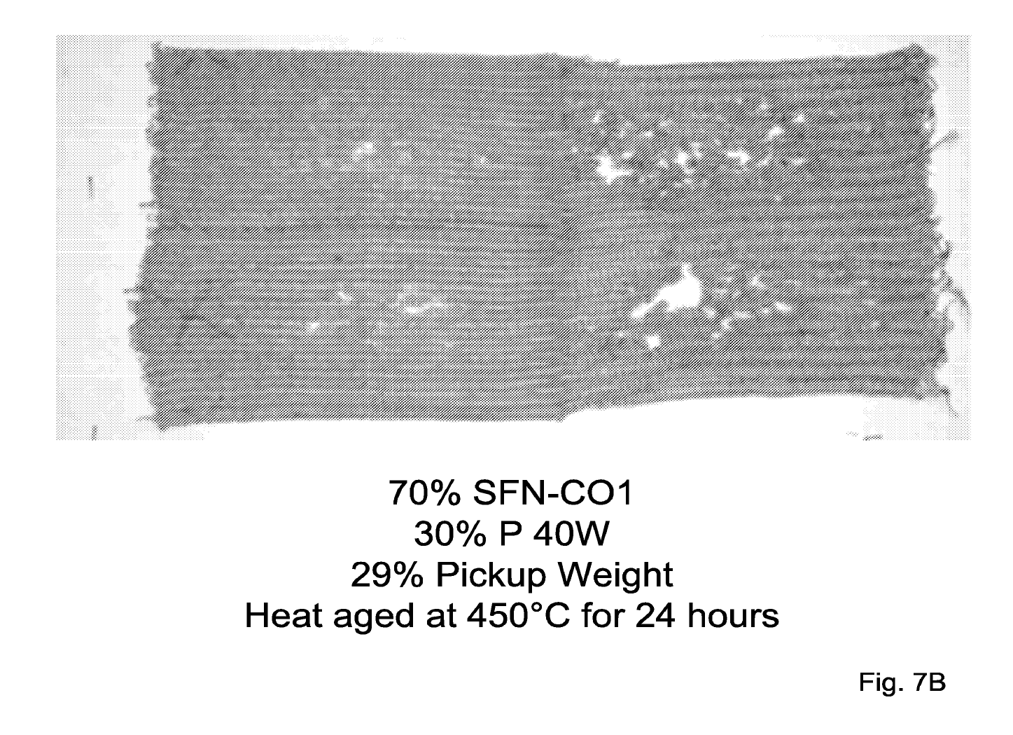

The same procedure as in Example 4 was used to prepare and test sleeves using a formulation consisting of 70 wt. % PTFE dispersion (SFN-CO1) and 30 wt. % methylphenylpolysiloxane (Evonik P 40W). Results are shown in FIGS. 7A and 7B. In FIGS. 7A and 7B, a sleeve has been folded over and used for two stone impingement tests. The sleeve is shown unfolded and split longitudinally, and the left side of the photograph shows the coated outer portion and the right side of the photograph shows the uncoated inner portion of the sleeve, where the top half of the figure indicates a first stone impingement test conducted on one side of the folded sleeve, and the bottom half of the figure indicates a second stone impingement test conducted on an opposite side of the folded sleeve.

In comparison to the sleeves from Example 5, after heat conditioning at 425° C. for 24 hours, the compositions from the two Examples provided similar durability to the coated portions of test pieces, and the composition of Example 5 appeared to provide somewhat better protection to the uncoated inner-portion of the article, although the difference in damage to the uncoated inner portion could be attributable to the difference in applied weight of the coating existing between those two test pieces. At a heat conditioning of 450° C. for 24 hours, there appears to be less damage to the sleeves in Example 6 relative to the sleeves from Example 5, although the application weights were similar between the two examples. The sleeves from Example 6 thus appear to have an improved response to the sleeves from Example 5 at the 450° C. conditioning temperature. Moreover, the composition used in Example 6 is softer and/or more extensible than the compositions used in Examples 1-5.

The foregoing description of preferred embodiments of the disclosure has been presented for purposes of illustration and description. It is not intended to be exhaustive or to limit the disclosure to the precise form disclosed. Modifications or variations are possible in light of the above teachings. The embodiments were chosen and described to provide the best illustrations of the principles of the disclosure and their practical application, thereby enabling one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally and equitably entitled.

1-17. (canceled)

18. A treated article, comprising:
a substrate comprising a body formed of knit mineral fibers; and
a treatment composition applied to and impregnated within said substrate, said treatment composition at least partially filling interstitial spaces between the knit mineral fibers, said treatment composition comprising:
at least one fluoropolymer; and
at least one co-resin different than said at least one fluoropolymer, said at least one co-resin selected from the group consisting of fluorinated ethylene-propylene (FEP), perfluoromethylvinyl ether (MFA), acrylic resins, silicone resins, ethylene-vinyl acetate (EVA), polyurethane dispersions (PUD), polyvinyl alcohol (PVOH) resins, polyvinylidine difluoride (PVDF) resins, polyvinyldichloride (PVDC) resins, polyetheretherketone (PEEK) resins, polyamideimide (PAI) resins, polyarylsulfone (PAS) resins, epoxy resins, polyester resins, polyvinyl chloride (PVC) resins, and melamine-formaldehyde resins.

19. The treated article of claim 18, wherein said at least one fluoropolymer is selected from the group consisting of polytetrafluoroethylene (PTFE), co-polymers of tetrafluoroethlyene and ethylene (ETFE), co-polymers of tetrafluoroethylene and hexafluoropropylene (FEP), co-polymers of tetrafluoroethylene and perfluorovinylether (PFA), co-polymers of tetrafluoroethylene and perfluoromethylvinyl ether (MFA) and polyvinylidene fluoride (PVDF), and co-polymers of tetrafluoroethylene, hexafluoropropylene, and vinylidene difluoride (THV).

20. The treated article of claim 18, wherein said co-resin comprises a polysiloxane of the formula: 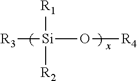
wherein x is an integer between 5 and 1000, R₁ and R₂ are the same or different, and are alkyl, aryl, alkoxyalkyl, alkoxyaryl, or hydroxyalkyl, and R₃ and R₄ are hydroxy, alkyl, aryl, or hydroxyalkyl.

21. The treated article of claim 18, wherein said at least one co-resin is methylphenylpolysiloxane.

22. The treated article of claim 18, wherein said at least one fluoropolymer is polytetrafluoroethylene (PTFE) and said at least one co-resin is methylphenylpolysiloxane.

23. The treated article of claim 18, wherein the content of said at least one fluorpolymer is between 50 and 95 wt. %, and the content of said at least one co-resin is between 5 and 50 wt. % of said treatment composition, based on solids content.

24. The treated article of claim 1, wherein said knit fibers are basalt fibers.

25. A method of treating a textile article, comprising:
providing a substrate comprising a body formed of knit mineral fibers;
applying a treatment composition to the substrate, the treatment composition impregnating the substrate and at least partially filling interstitial spaces between the knit mineral fibers, the treatment composition comprising:
at least one fluoropolymer; and
at least one co-resin different than the at least one fluoropolymer, the at least one co-resin selected from the group consisting of fluorinated ethylene-propylene (FEP), perfluoromethylvinyl ether (MFA), acrylic resins, silicone resins, ethylene-vinyl acetate (EVA), polyurethane dispersions (PUD), polyvinyl alcohol (PVOH) resins, polyvinylidine difluoride (PVDF) resins, polyvinyldichloride (PVDC) resins, polyetheretherketone (PEEK) resins, polyamideimide (PAI) resins, polyarylsulfone (PAS) resins, epoxy resins, polyester resins, polyvinyl chloride (PVC) resins, and melamine-formaldehyde resins; and
curing the treatment composition.

26. The method of claim 25, wherein the knit fibers are basalt fibers.

27. The method of claim 25, wherein the at least one fluoropolymer is selected from the group consisting of polytetrafluoroethylene (PTFE), co-polymers of tetrafluoroethlyene and ethylene (ETFE), co-polymers of tetrafluoroethylene and hexafluoropropylene (FEP), co-polymers of tetrafluoroethylene and perfluorovinylether (PFA), co-polymers of tetrafluoroethylene and perfluoromethylvinyl ether (MFA) and polyvinylidene fluoride (PVDF), and co-polymers of tetrafluoroethylene, hexafluoropropylene, and vinylidene difluoride (THV).

28. The method of claim 8, wherein said co-resin comprises a polysiloxane of the formula: 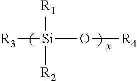
wherein x is an integer between 5 and 1000, R₁ and R₂ are the same or different, and are alkyl, aryl, alkoxyalkyl, alkoxyaryl, or hydroxyalkyl, and R₃ and R₄ are hydroxy, alkyl, aryl, or hydroxyalkyl.

29. The method of claim 25, wherein said at least one co-resin is methylphenylpolysiloxane.

30. The method of claim 25, wherein said at least one fluoropolymer is polytetrafluoroethylene (PTFE) and said at least one co-resin is methylphenylpolysiloxane.

31. The method of claim 25, wherein the content of said at least one fluorpolymer is between 50 and 95 wt. %, and the content of said at least one co-resin is between 5 and 50 wt. % of said treatment composition, based on solids content.

32. The method of claim 25, wherein said curing step comprises heat curing the treatment composition.

33. The method of claim 25, wherein the treatment composition is applied to the substrate by immersing the substrate into the treatment composition.
